(19) United States
(12) Patent Application Publication
(10) Pub. No.: US 2005/0018888 A1
(43) Pub. Date: Jan. 27, 2005

(54) Method, system and computer program of visualizing the surface texture of the wall of an internal hollow organ of a subject based on a volumetric scan thereof

(76) Inventor: Frans Wessel Zonneveld, Middlebeers (NL)

Correspondence Address: Thomas M Lundin;Philips Intellectual Property & Standards, 595 Miner Road, Cleveland, OH, 44143, US

(21) Appl. No.: 10/498,712

(22) PCT Filed: Dec. 12, 2002
(86) PCT No.: PCT/IB02/05480

(30) Foreign Application Priority Data
Dec. 14, 2001 (EP) 01204907.8

(51) Int. Cl. G06K 9/00

(52) U.S. Cl. 382/128; 382/154

(57) ABSTRACT

The invention concerns a method of visualising an internal hollow organ (1) of a subject based on a volumetric scan thereof. A three-dimensional image of the internal hollow organ is reconstructed in which a layer (2) of a predetermined depth (d) in at least part of the wall surface is defined. Property values associated with the segments of the layer are determined to which visualisation parameters are assigned. The visualisation parameters are added to the three-dimensional display in order to show the wall structure of the internal hollow organ as a texture map. The invention also refers to a system for visualising an internal hollow organ of a subject based on a volumetric scan thereof, which system comprises means for carrying out the steps of the method according to the invention. The invention also relates to a computer program to carry out the method according to the invention.

The present invention relates to a method of visualising an internal hollow organ of a subject based on a volumetric scan thereof, said method comprising the step of:
a)Reconstructing a three-dimensional image of the internal surface of the hollow organ.

Such a method is known in the art and forms the basis for a number of computer programs designed by different experts in the field providing a technique called “virtual endoscopy”. Based on a volumetric scan of a patient, for instance generated by means of Computed Tomography, a data model is created from which three-dimensional endoscopic images are reconstructed by means of known three-dimensional reconstruction techniques. These 3D endoscopic images provide a view as seen from a vantage point that lies within the hollow organ close to the internal surface thereof. Such computer programs offer a medically skilled person an opportunity to examine the internal organs of the patient without the need for invasive examination like true endoscopy. The thus reconstructed 3D endoscopic images can for instance be evaluated on a computer by a medically skilled person for diagnosis.

The known method has the disadvantage that although the resulting 3D images are a true representation of the shape of the internal surface of the hollow organ, the texture is missing. Said texture generally may reveal important additional information about the structural detail of the surface, such as the vascularisation pattern. The lack of texture is an important reason why physicians still tend to choose truly invasive examination over virtual examination.

It is an object of the method according to the invention to provide a method of the type as described above that can visualise certain properties of the surface as a texture on the surface of the internal hollow organ.

The method according to the invention is therefore characterised in that the method further comprises the steps of:
b) Defining a layer of a predetermined depth in at least part of the wall surface of the hollow organ;
c) Determining property values associated with the segments of the layer;
d) Assigning visualisation parameters to the property values; and
e) Adding the visualisation parameters to the three-dimensional image as a texture map in order to show the wall structure of the internal hollow organ.

The method according to the invention thus can visualise the vascularisation pattern as part of the texture of the surface of the hollow organ. Changes in the vascularisation pattern allow to make a distinction between different types of abnormalities, such as polyps or retained stool, and even to differentiate between benign and malignant abnormalities, the details of which are referred to in the preferred embodiments as part of the sub claims.

In a first preferred embodiment of the method according to the invention step c) comprises the step of: Determining the maximum intensity value for each group of segments in a direction essentially perpendicular to the internal surface of the hollow organ. By determining the maximum intensity the details of malignant abnormalities become clearly visible as the associated tissue usually shows higher intensity values, due to a higher concentration of blood vessels.

According to another preferred embodiment of the method according to the invention step c) further comprises the step of: Determining the minimum intensity value for each group of segments in a direction essentially perpendicular to the internal surface of the hollow organ. The minimum intensity value provides additional information about areas having lower intensity values, such as air, which may indicate the presence of retained stool or a loop in the colon. The use of this additional information may aid in preventing misdiagnosis.

In yet another preferred embodiment the method step d) further comprises the step of: Assigning colour values to the property values according to a predetermined colour scheme. By choosing the real colours associated with the tissue a natural impression can be given of the texture of the surface.

Preferably step e) further comprises the step of: Superimposing the colour values to the three-dimensional image in order to show the wall structure of the internal hollow organ. In a fairly efficient way the texture can thus be integrated in the existing 3D model.

According to a refined embodiment of the method step b) further comprises the step of: Defining a layer of a predetermined depth essentially corresponding to the depth of the mucosa on the wall surface of the internal hollow organ. This embodiment is especially developed for use with internal hollow organs that are coated with mucosa, such as the colon or the trachea. The blood vessels of the mucosa provide all relevant information about the texture of the surface.

Interesting property values comprise density values or thickness values of the layer in general, and more specific of the mucosa.

The invention further relates to a system for visualising an internal hollow organ of a subject based on a volumetric scan thereof, which systems comprises means for carrying out the steps of the method according to the invention.

The invention also concerns a computer program to carry out the method according to the invention.

The invention will be further explained by means of the attached drawing, in which:

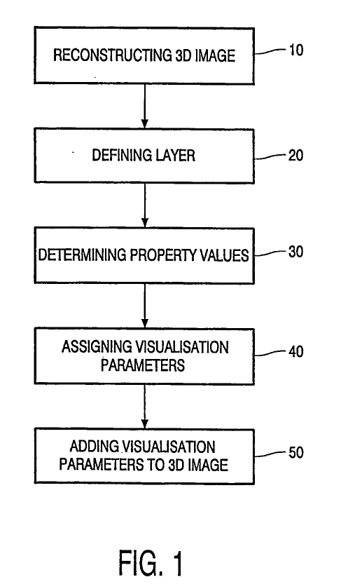

FIG. 1 shows a flow diagram presenting an overview of the steps of the method according to the invention; and

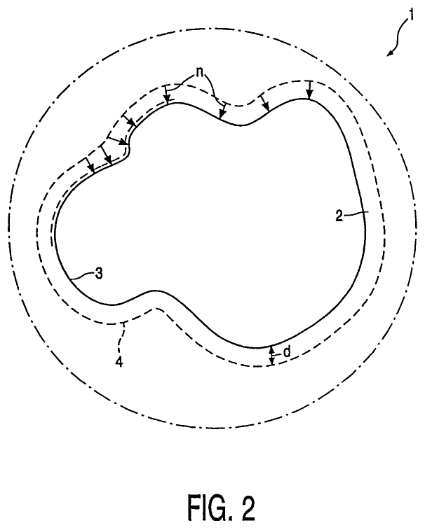

FIG. 2 schematically shows a cross section through the colon wall as an illustration of step 20 of the method according to the invention.

In general the method according to the invention refers to virtual techniques for examination of a subject, which is usually a human patient, but can also for instance be an animal. Said techniques allow an inner view of hollow structures of the subject, e.g. organs, blood vessels, etc., by means of computer graphics. A virtual camera is placed in a three-dimensional data volume representing (part of) the subject. The method according to the invention will now be described according to a preferred embodiment, which relates to virtual endoscopy performed on a human patient.

In order to require the 3D patient data several known medical examination techniques can be used, such as Computed Tomography (CT) or Magnetic Resonance Tomography (MR). The 3D data are visualised by means of known three-dimensional reconstruction techniques. For this purpose different suitable volume rendering techniques are known in the field of computer graphics. Preferably use is made of iso-surface volume rendering techniques, which are for instance described in the article “Iso-surface volume rendering”, by M. K. et al., Proc. of SPIE Medical Imaging '98, vol. 3335, pp 10-19. Thus a virtual environment is created that simulates endoscopy.

The method comprises the following technical steps:

Step 10: Reconstructing a three-dimensional image of the internal surface of the hollow organ.

A variety of visualisation techniques are available to the person skilled in the art to simulate a three-dimensional view of the colon. Several examples include:
a) the “view point” technique also referred to as virtual endoscopy, wherein a user navigates through the colon;
b) the “unfolded cube” technique, wherein the colon wall is projected onto the walls of a cube, which is next unfolded to provide a natural view of the colon; and
c) the “stretched path” technique, wherein the colon wall is projected onto the walls of a cylinder, which is next unfolded and stretched.

The view point technique is a classical technique that is known in the art and among others described by Rogalla P, Terwisscha van Scheltinga J, Hamm B (Eds) in “Virtual endoscopy and related 3D techniques”, Berlin, Springer Verlag (2001). This book is part of the series Medical Radiology Diagnostic Imaging edited by: Baert A L, Sartor K, en Youker J E. The unfolded cube technique is in more detail described in the article “Quicktime VR- an image based approach to virtual environment navigation”, by S. E. Chen, SIGGRAPH 95, held on 6-11 August 1995, Los Angeles, Calif., USA, Conference Proceedings, Annual Conference Series, pages 29-38. The stretched path technique is in more detail described in the following article by D. S. Paik, C. F. Beaulieu, R. B. Jeffrey, Jr., C. A. Karadi, S. Napel, “Visualization Modes for CT Colonography using Cylindrical and Planar Map Projections.” J Comput Assist Tomogr 24(2), pages 179-188, 2000.

All techniques result in a segmentation of the colon based on a voxel model comprising the data of a volumetric scan that is projected on a flat surface and represented as a surface model.

Step 20: Defining a layer of a predetermined depth in at least part of the wall surface of the internal hollow organ.

This step is illustrated by means of FIG. 2 showing a cross section through the colon 1. In order to define such a layer 2 the two surfaces 3, 4 defining the boundaries of the layer 2 need to be defined. Dilation procedures known in the art can be used for this purpose and are for instance described by Giardina CR and Daugherty ER in “Morphological methods in image processing”, Upper Saddle River N.J., U.S.A., Prentice Hall (1988). Surface 3 starts preferably on or slightly after the air-tissue transition depending on the technique used.

When the internal hollow organ is coated with mucosa, as is the case with the colon or trachea, the depth (d) of the layer is preferably defined essentially equal to the depth of the mucosa, which generally lies between 2 and 4 mm for the colon.

Step 30: Determining property values associated with the voxels in the layer.

Many interesting property values can be thought of, such as density values or thickness values. In order to determine the density values preferably a technique known in the art as Maximum Intensity Projection (MIP) is used. For a detailed description of this technique reference is made to the article “A fast progressive method of maximum intensity projection” by Kim K. H. and Park H. W., published in Comput. Med. Imaging Graph. 2001, September-October;25(5):pages 433-441.

Herein the maximum intensity value for each group of voxels in a direction essentially perpendicular to the surface of the internal hollow organ is determined. A number of normal vectors (n) are shown in FIG. 2 illustrating the direction perpendicular to the surface wall. The direction of these vectors can be established based on known techniques, such as surface rendering techniques, one of which is for instance described in the article “Iso-surface volume rendering”, by M. K. et al., Proc. of SPIE Medical Imaging '98, vol.3335, pp 10-19. The direction can also be found by an algorithm known in the art using a gradient of Hounsfield numbers of the tissue that is for instance described by Hoehne K H, Bernstein R, “Shading 3D images from CT using grey-level gradients”, IEEE Transactions on Medical Imaging, Vol. 5, Nr 1 (1986), pages 45-57. In short according to this algorithm the direction of the maximum gradient is determined in sub volumina comprising a number of voxels. The voxel lying in the centre of such a sub volume needs to lie at the segmentation surface. The direction of the maximum gradient found is set equal to the direction of the normal to the surface. This normal vector can be found for each voxel forming part of the segmentation surface.

Preferably the group of voxels for which the (maximum) intensity value is determined, as mentioned above, includes all voxels the centre of which lies in a predetermined sub volume. To define each sub volume an imaginary line is drawn in the produced part of a normal vector penetrating the tissue. Part of the dimensions of the sub volume is defined depending on the resolution of the data. As an example the sub volume may have a width of approximately one voxel, preferably half a voxel on each side of the normal vector. The depth of the sub volume will generally be defined by the depth of the layer.

In case of an MIP surface 3 starts on the air-tissue transition. Preferably an MIP is determined for all normal vectors in the layer. Depending on the application and the users wishes the layer may cover the entire internal wall of the object under examination or a selected part of it.

A malignant abnormality, such as a tumour, will result in higher intensity values compared to those of the surrounding tissue and can now be easily distinguished.

Additionally a technique known in the art as Minimum Intensity Projection (mIP) may be used. This technique is described in the article “Three-dimensional spiral CT cholangiography with minimum intensity projection in patients with suspected obstructive biliary disease: comparison with percutaneous transhepatic cholangiography” by Park S J, Han J K, Kim T K and Choi B I, published in Abdom. Imaging. 2001, May-June; 26(3) pages 281-286. Herein the minimum intensity value for each group of voxels in a direction essentially perpendicular to the surface of the internal hollow organ is determined. With respect to all other details the procedure is analogous to the procedure described above for MIP. Application of the mIP provides additional information about benign abnormalities found in the wall structure of the object. For instance, contamination, such as retained stool, may be present in the colon. The mIP will signal this by presenting a very low intensity value at the location of the contamination due to the presence of air bubbles and the lack of contrast medium therein. The organ may also contain loops, which may lead to erroneous information in case the layer 2 inadvertently comprises more than just the intended mucosa at one location. This situation will also be signalled by the mIP presenting a very low intensity value at the location of the loops. As the location of the loops usually will be significantly larger than the location of the contamination, a distinction can be made by taking into account the size of the abnormality as well. In case of an mIP surface 3 starts slightly after the air-tissue transition. Preferably a margin corresponding to the width of the spatial resolution (typically half a slice in case of CT data) is used.

As an alternative to the density values visualised as described above other property values may be visualised, such as thickness values of the layer 2. To this end a number of the above described techniques can also be used. In addition thereto the border between the layer 2 and the layer behind it should be established. In the example described wherein layer 2 is the mucosa layer, the layer behind it usually is a layer of fat. The border between these layers can for instance easily be determined by determining the Hounsfield number, which differs greatly for mucosa and fat tissue.

Step 40: Assigning visualisation parameters to the property values.

In order to make the variation in property values found in the surface of the inner wall of the organ visible, different visualisation parameters are assigned to corresponding different property values according to a predetermined scheme. Preferably colour values are assigned to the property values according to a predetermined colour scheme, such as a colour look-up table.

A suitable colour scheme for visualisation of the density of the colon may range from yellow (f.i. when the intensity value=0) to (dark) red for higher intensity values. A suitable colour scheme for the density of the trachea may range from pink (f.i. when the intensity value=0) to (dark) red for higher intensity values.

The thickness of the (mucosa) layer can be visualised using any suitable colours. An example may be red for normal thickness and darker colours, such as green or blue, for thicker areas. The thinner areas may be represented in lighter colours, such as orange or yellow.

It is noted that many other suitable visualisation parameters will be apparent to a person skilled in the art, such as grey values, patternising values etc.

Step 50: Adding the visualisation parameters to the three-dimensional image as a texture map in order to show the wall structure of the internal hollow organ.

Finally the visualisation parameters need to be incorporated in the three-dimensional image in order to show the wall structure of the internal hollow organ. Preferably the parameter values are superimposed onto the three-dimensional image thus revealing more surface details.

The method according to the invention is preferably carried out by a system for visualising an internal hollow organ of a subject based on a volumetric scan thereof, which systems comprises means for carrying out the steps of the method according to the invention. Said means preferably comprise a computer program. Based on the explanation given herein a skilled person will be able to translate the steps of the method into such a computer program to carry out the method.

The system described can be directly coupled to the data acquisition system for acquiring the data of the subject concerned. This data set can be acquired by means of various techniques, such as 3D X-ray rotational angiography, computed tomography, magnetic resonance imaging or magnetic resonance angiography. When the method according to the invention is applied to a human patient, the patient preferably is administered a contrast agent suitable for medical use. The type of contrast agent depends on the application and can for instance be an intravenous contrast agent to aid in distinguishing the blood vessels on the inner surface wall of the colon or trachea.

Summarising the invention refers to a post-processing method for visualising variations in property values, such as density or thickness of the inner surface wall of hollow objects in order to reveal more detail thereof. The method is especially developed to increase the accuracy of patient diagnosis. Application of this method in combination with known virtual visualisation methods, such as virtual endoscopy, results in a virtual image yielding the same information as corresponding invasive medical examination methods, such as colonoscopy and bronchioscopy.

The invention is of course not limited to the described or shown embodiment. The method may be used to visualise surface details of other medical objects, such as blood vessels or trachea, and may even be used outside the field of medicine. The invention therefore generally extends to any embodiment, which falls within the scope of the appended claims as seen in light of the foregoing description and drawings.

1. A method of visualising an internal hollow organ of a subject based on a volumetric scan thereof, said method comprising the step of:
a) Reconstructing a three-dimensional image of the internal surface of the hollow organ; Characterised in that the method further comprises the steps of:
b) Defining a layer of a predetermined depth (d) in at least part of the wall surface of the hollow organ;
c) Determining property values associated with the segments of the layer;
d) Assigning visualisation parameters to the property values; and
e) Adding the visualisation parameters to the three-dimensional image as a texture map in order to show the wall structure of the internal hollow organ.

2. A method according to claim 1, wherein step c) comprises the step of:
(i) determining the maximum intensity value for each group of segments in a direction (n) essentially perpendicular to the internal surface of the hollow organ.

3. A method according to claim 10, wherein step c) further comprises the step of:
(i) Determining the minimum intensity value for each group of segments in a direction (n) essentially perpendicular to the internal surface of the hollow organ.

4. A method according to claim 1, 2 or 3, wherein step d) further comprises the step of:
(i) Assigning colour values to the property values according to a predetermined colour scheme.

5. A method according to claim 4, wherein step e) further comprises the step of:
(i) Superimposing the colour values to the three-dimensional image in order to show the wall structure of the internal hollow organ.

6. A method according to claim 1, wherein step b) further comprises the step of:
(i) Defining a layer of a predetermined depth (d) essentially corresponding to the depth of the mucosa on the wall surface of the internal hollow organ.

7. A method according to claim 1, wherein the property values comprise density values of the layer.

8. A method according to claim 1, wherein the property values comprise thickness values of the layer.

9. A system for visualising an internal hollow organ of a subject based on a volumetric scan thereof, which systems comprises means for carrying out the steps of the method according to claim 1.

10. Computer program to carry out the method according to claim 1.
